(19) United States
(12) Patent Application Publication
(10) Pub. No.: US 2011/0275245 A1
(43) Pub. Date: Nov. 10, 2011

(54) ELECTRICAL PLUG-IN CONNECTOR FOR APPLICATIONS CRITICAL TO PLUG SAFETY

(76) Inventor: Alfred ANNECKE, Heilbronn (DE)

(21) Appl. No.: 13/036,399

(22) Filed: Feb. 28, 2011

(30) Foreign Application Priority Data
May 7, 2010 (DE) 102010019877.3

(51) Int. Cl. H01R 13/70; H01R 24/58

(52) U.S. Cl. 439/620.21; 439/660

(57) ABSTRACT

The invention relates to an electrical plug-in connector for applications critical to plug safety, with a socket (2) and a plug (1) and the following features:
the socket (2) has two contacts (5, 7) which are connected to an electrical consumer (8),
the plug (1) has two mating contacts (4, 6) which are connected or can be connected to a control device (12) for electrical contact-making of the contacts (5, 7),
   characterized in that the electrical plug-in connector has switching means for detection of an operating position of the electrical plug-in connector by the control device (12).

The invention relates to an electrical plug-in connector for applications critical to plug safety, with a socket and a plug as claimed in Claim 1.

Electrical plug-in connectors for applications critical to plug safety, such as for example airbag connectors, have had shorting jumpers in the igniter which is generally made as a socket, the socket contacts necessary for pin contact-making in the electrical plug-in connector being electrically separate from one another in the insulating body of the igniter. A shorting jumper in the igniter of the airbag module briefly short circuits the two pins until the plug-in connector is plugged in and the short circuit is cleared by pressure on the secondary interlock.

As a result of the cost pressure which is rising especially in the automobile industry and continually rising miniaturization pressure there is a demand for simple, space-saving and at the same time versatile, but at least equally safe electrical plug-in connectors for applications critical to safety.

Therefore the object of this invention is to provide an electrical plug-in connector which solves the aforementioned technical problems.

This object is achieved with the features of Claim 1. Advantageous developments of the invention are given in the dependent claims. All combinations of at least two of the features given in the specification, the claims and/or the figures also fall within the framework of the invention. At the given value ranges, values which are within the indicated limits will also be disclosed as boundary values and will be claimed in any combination.

The invention is based on the idea of devising an electrical monitoring possibility of the position of the plug in the socket of the igniter, especially of the operating position, accordingly a completely plugged-in position, for an existing secondary interlock of the completely plugged-in and secondary-interlocked position, by a switch being integrated into the plug-in connector which is connected or connectable to the control device and which is made to detect at least the operating position of the electrical plug-in connector. Due to this measure the electrical plug-in connector can be used in a more versatile manner at the same time since a switch can be disconnected both without and also with secondary interlock and/or shorting jumper for the most varied electrical plug-in connectors in at least a similar or identical manner. Thus at the same time the costs of the electrical plug-in connector can also be reduced since a separate shorting jumper as used in the prior art can be omitted and nevertheless monitoring of the correct seat of the plug-in connector, i.e. the operating position, is enabled. As claimed in the invention the electrical plug-in connection according to one preferred embodiment, besides the switching means, does not comprise any additional switching bodies, such as for example a separate shorting jumper so that it can be omitted.

The mating contacts of the socket which are necessary for the contact-making of the contacts of the socket, i.e. the pins, are in the plug of the plug-in connector, specifically insulated in a spring body. When the electrical plug-in connector is not plugged in, the mating contacts have an electrical connection which can be switched, according to one embodiment of the invention.

In one version of an electrical plug-in connector without a secondary interlock, an insulating rib of the socket when the plug-in connector is plugged in clears the electrical contact between the two mating contacts, as a result of which a switch is formed. The control device can accordingly detect the change of the switching state, especially the resistance of the ignition coil which is connected to the two contacts. Then the control device can allow the trigger current for the ignition process to flow unhindered into the igniter. The insulating rib in an advantageous configuration is positioned in the insulating ring, especially between the plugs.

In one version of the electrical plug-in connection with secondary interlock which can be made as a separate or prelocked secondary interlock, there is an electrical connection between the mating contacts even after the plug is fully plugged in the socket and the connection between the mating contacts is broken only by the secondary interlock so that the switching means are formed at least partially by the secondary interlock. On the secondary interlock for this purpose there is an insulating rib which is made to clear the connection, especially the short circuit between the mating contacts as soon as the rib has been or is being moved into the interlock position with the secondary interlock. The control device in the interlocked position detects the resistance of the ignition coil located between the contacts and the trigger current can flow unobstructed from the control device to the igniter.

According to one advantageous embodiment of the invention, it is provided that the switching means be located at least in part between the mating contacts. This ensures space-saving accommodation of the switching means.

By the switching means comprising a secondary interlock with one interlock position, the operation of the secondary interlock can be combined with the operation of the switching means, yielding synergy effects such as saving space and material.

The switching means advantageously comprise a shorting jumper/switch which is activated especially mechanically. The shorting jumper is designed to act especially between the mating contacts and/or is formed by them; this distinguishes it from the prior art, associated with the advantage that the switching means are located nearer on the electrical control device and can be connected more easily to the electrical control device. Functionally a synergy effect also arises here such that parts of the shorting jumper or the shorting jumper as such can be used as switching means.

In another advantageous embodiment it is provided that the switching means are formed at least in part, especially the switch, by the mating contacts, especially in one piece.

According to another advantageous embodiment of the invention it is provided that the switching means each comprise a line which is connected to each mating contact, and by which each mating contact is connected or can be connected to the control device.

To the extent the electrical resistance of the electrical consumer can be measured in the operating position of the plug-in connector by the switching means, the determination of the switching position is coupled to the determination of operation of the ignition process so that very high safety of the ignition process can be ensured. Furthermore it is possible as claimed in the invention to display the function or malfunction of the igniter or plug-in connector in a display means so that faults can be corrected.

According to another preferred embodiment of the invention it is provided that the secondary interlock be made to disconnect the shorting jumper in the interlock position. In this way the secondary interlock acquires a double function, specifically the function of interlocking the primary interlock and at the same time disconnecting the shorting jumper which is formed by the switching means.

In another advantageous embodiment of the invention it is provided that the socket be made to disconnect the shorting jumper in the operating position. This alternative embodiment yields a double function of a shorting jumper of the igniter, specifically that of the shorting jumper according to the prior art and at the same time that of the switching means as claimed in the invention.

Other advantages, features and details of the invention will become apparent from the following description of preferred exemplary embodiments and using the drawings.

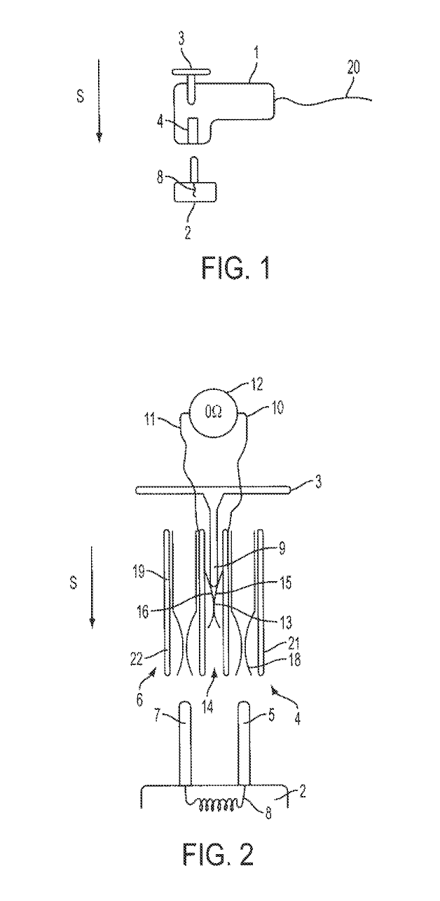

FIG. 1 shows a schematic sectional view of the electrical plug-in connector as claimed in the invention with secondary interlocking means,

FIG. 2 shows a schematic sectional view of the functional components of the electrical plug-in connector in an unplugged position,

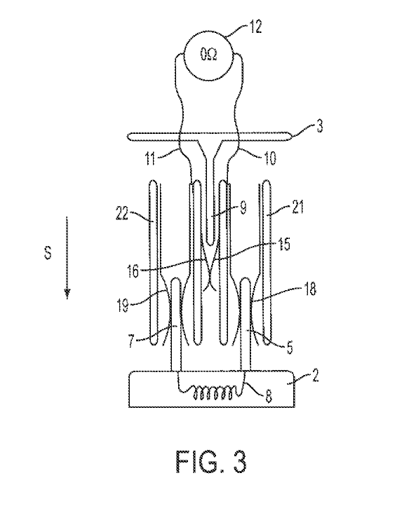

FIG. 3 shows a schematic cross sectional view of the functional components of the electrical plug-in connector as claimed in the invention in a primary interlock position,

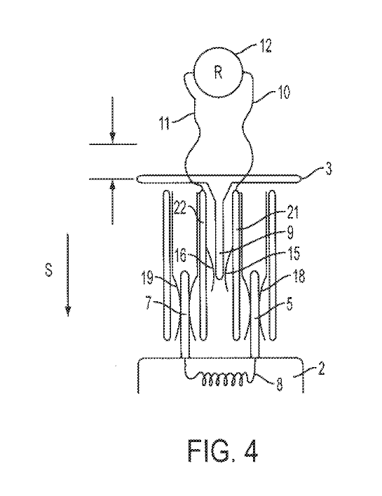

FIG. 4 shows a schematic cross sectional view of the functional components of the electrical plug-in connector as claimed in the invention in one operating position and

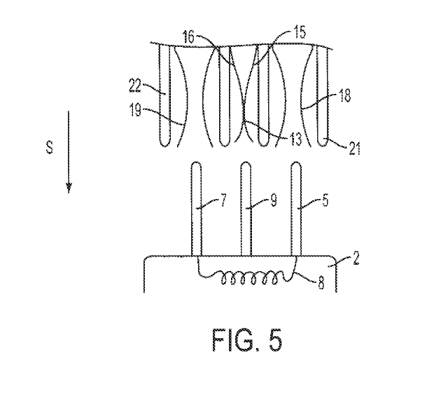

FIG. 5 shows as claimed in the invention a schematic cross sectional view of the functional components of one alternative embodiment of the electrical plug-in connector as claimed in the invention in an unplugged position.

In the figures the same components or components with the same function are identified with the same reference numbers.

FIG. 1 shows an electrical plug-in connection which consists of a plug 1 and a socket 2 and which is connected or which can be connected via a cable set 20 to a control device 12 in order to trigger an airbag via an ignition coil 8 in the case of a collision. It is a highly safety-relevant application so that the electrical plug-in connection must ensure a plug-in connection which is reliable over years of operation of a corresponding vehicle and which works one-hundred percent in spite of harsh ambient conditions (vibration, moisture, etc.).

The plug 1 has mating contacts 4, 6 to contacts 5, 7 of the socket 2, the mating contact 4 corresponding to the contact 5 and the mating contact 6 corresponding to the contact 7. Furthermore there are known orientation ribs, etc. to prevent incorrect mating.

Moreover the plug 1 has a secondary interlock 3 which is used for interlocking a primary interlock which is not show here in the conventional manner.

The electrical plug-in connector is shown greatly enlarged in FIGS. 1 to 5 since the electrical plug-in connectors are extremely small, with heights of less than 2 cm, to some extent far less than 1 cm; this makes it very difficult to solve the technical problems of plug-in connectors which are to be produced in mass production.

FIG. 2 shows the electrical plug-in connector only schematically with its important components to illustrate the functionality of the switching means which are provided as claimed in the invention.

The ignition coil 8 is electrically connected to the pin-shaped contacts 5 and 7 which are arranged parallel and at a distance to one another and can make contact with mating contacts 4 and 6 which are aligned to the contacts 5 and 7 in the plug, the mating contacts 4 and 6 encompassing the mating contact springs 18, 19 which hold the contacts 5, 7. A permanent electrical connection between the contacts 5, 7 and the mating contacts 4, 6 is achieved by a spring pressure directed radially to the inside by the mating contact springs 18, 19 on the contacts 5, 7, as is shown in FIG. 3 in the plugged-in state. The mating contact springs 18, 19 are supported and held by the electrically conductive mating contact sockets 21, 22 of the mating contacts 4, 6, which sockets surround the mating contact springs 18, 19.

In a switching means space 14 which is located between the mating contacts 4, 6 there is a switch 13, here in the form of a shorting jumper, between the mating contact 4 and the mating contact 6, which is formed from two spring arms 15, 16. The spring arm 15 is connected in an electrically conductive manner to the mating contact 4, while the spring arm 16 opposite the spring arm 15 is connected in an electrically conductive manner to the mating contact 6. The spring arms 15, 16 as claimed in the invention are molded, preferably in one piece, to the mating contacts 4, 6, especially to the mating contact sockets 21, 22. The spring arms 15 and 16 in one plug-in direction S of the plug 1 are arranged especially parallel to the mating contacts 4, 6 and run at one another, each spring arm 15, 16 applying a spring force in the direction of the spring arm 15, 16 which is opposite at the time, so that the spring arms 15, 16 are electrically in contact in one contact region 17 until the operating position shown in FIG. 4 is reached and the spring arms 15, 16 are pressed apart by an insulating rib 9 of the secondary interlock 3 against the force of the spring arms 15, 16. Thus, in the operating position the short circuit produced by the switch 13 between the mating contacts 4 and 6 is interrupted so that there is an electrical connection only via the ignition coil 8 which was switched in parallel beforehand to the shorting jumper formed by the switch 13.

Lines 10 and 11 connect the mating contacts 4, 6 or the spring arms 15, 16 via electric lines 10, 11 to the control device 12. In the control device 12 the resistance can be measured which prevails in the circuit formed by the lines 10, 11, the spring arms 15, 16, the mating contacts 4, 6, the contacts 5, 7 and the ignition coil 8. The resistance is determined essentially in the operating position which is shown in FIG. 4 by the resistance of the ignition coil 8 so that the operating position can be detected as shown in FIG. 4 by the control device 12.

In the embodiment as shown in FIGS. 2 to 4 the switching means are formed by the rib 9 and the spring arms 15, 16, the lines 10, 11 and the geometrical dimensions, especially the length of the rib 9 which is responsible for the disconnection of the short circuit of the shorting jumper formed by the switch 13.

FIG. 5 shows one alternative embodiment of the invention in which the secondary interlock 3 can be omitted. One rib 9′ for interrupting the shorting jumper formed by the switch 13 between the spring arm 15 and the spring arm 16 is located on the socket 2 between the contacts 5, 7. The rib 9′ interrupts the shorting jumper as soon as the plug 1 is plugged at least largely into the socket 2 and is locked to it in the primary interlock. Otherwise, the operation, especially of the control device 12 and the lines 10, 11 as well as the mating contacts 4, 6 in interaction with the spring arms 15, 16 is described identically to FIGS. 2 to 4.

### REFERENCE NUMBER LIST

1 plug
2 socket
3 secondary interlock
4, 6 mating contacts
5, 7 contacts
8 ignition coil
9, 9′ rib
10, 11 lines
12 control device
13 switch
14 switching means space
15 spring arm
16 spring arm
17 contact region
18, 19 mating contact springs
20 line set
21, 22 mating contact sockets
S plug-in direction

1. Electrical plug-in connector for applications critical to plug safety, comprising a socket (2) and a plug (1) wherein:
the socket (2) has two contacts (5, 7) which are connected to an electrical consumer (8),
the plug (1) has two mating contacts (4, 6) which are connected or can be connected to a control device (12) for electrical contact-making of the contacts (5, 7), and wherein the electrical plug-in connector has switching means for detection of the operating position of the electrical plug-in connector by the control device (12).

2. Plug-in connector as claimed in claim 1, wherein the switching means are located at least in part between the mating contacts (4, 6).

3. Plug-in connector as claimed in claim 1, wherein the switching means encompass a secondary interlock (3) with one interlock position.

4. Plug-in connector as claimed in claim 1, wherein the switching means encompass a switch (13), especially a mechanically actuated one.

5. Plug-in connector as claimed in claim 1, wherein the switching means are formed at least in part, especially the switch (13), by the mating contacts (4, 6), especially each in one piece.

6. Plug-in connector as claimed in claim 1, wherein the switching means each encompass one line (10, 11) which is connected to each mating contact (4, 6) and by which each mating contact (4, 6) is connected or can be connected to the control device (12).

7. Plug-in connector as claimed in claim 1, wherein the electrical resistance of the electrical consumer can be measured in the operating position of the plug-in connector by the switching means.

8. Plug-in connector as claimed in claim 3, wherein the secondary interlock (3) is made to disconnect the switch (13) in the interlock position.

9. Plug-in connector as claimed in claim 4, wherein the socket (2) is made to disconnect the switch (13) shortly before reaching the operating position or upon reaching the operating position.
